(19) United States
(12) Patent Application Publication
(10) Pub. No.: US 2016/0275425 A1
(43) Pub. Date: Sep. 22, 2016

(54) EVENT-TRIGGERED REASSIGNMENT OF TIME-LIMITED RESOURCES

(71) Applicants: Boyi Ni, Jiangsu (CN); Bilei Zhu, Shanghai (CN); Yu Cheng, Shanghai (CN); Wen-Syan Li, Fremont, CA (US)

(72) Inventors: Boyi Ni, Jiangsu (CN); Bilei Zhu, Shanghai (CN); Yu Cheng, Shanghai (CN); Wen-Syan Li, Fremont, CA (US)

(21) Appl. No.: 14/663,697

(22) Filed: Mar. 20, 2015

(51) Int. Cl. G06Q 10/06; G06Q 10/08

(52) U.S. Cl. CPC G06Q 10/06312; G06Q 10/083

(57) ABSTRACT

Methods, systems, and computer-readable storage media for event-triggered reassignment of time-limited resources. Implementations include actions of receiving an event indicator, determining a particular demand and associated particular time-limited resources based on the event indicator, identifying, for the particular demand, one or more first candidate demands in an assignment plan, the assignment plan including a plurality of demands associated with a plurality of time-limited resources, each first candidate demand and associated time-limited resources satisfying one or more constraints defined by the particular demand and associated particular time-limited resources, determining whether at least one of the first candidate demands has not been processed, and performing an action based on a result of determining whether at least one of the first candidate demands has not been processed.

### BACKGROUND

Supplies of time-limited resources usually can from loss caused by sudden changes in demand. In some examples, time-limited resources include resources that are no longer usable after a period of time (e.g., resources that spoil). That is, time-limited resources include resources that become obsolete after a period of time. Thus, the time-limited resources should be scheduled and prepared beforehand and/or delivered to demanders in-time. When unexpected changes in demand occurs (e.g., order cancelling), an alternative demand is expected where a reassignment of the resources can still meet the in-rime requirement as well as resources' validity period. However, if resources for the alternative demand have already been prepared, the difficulty in reassigning the resources is compounded.

### SUMMARY

Implementations of the present disclosure include computer-implemented methods for event-triggered reassignment of time-limited resources. In some implementations, actions include receiving an event indicator; determining a particular demand and associated particular time-limited resources based on the event indicator; identifying for the particular demand, one or more first candidate demands in an assignment plan, the assignment plan including a plurality of demands associated with a plurality of time-limited resources, each first candidate demand and associated time-limited resources satisfying one or more constraints defined by the particular demand and associated particular time-limited resources; determining whether at least one of the first candidate demands has not been processed; and performing an action based on a result of determining whether at least one of the first candidate demands has not been processed. Other implementations of this aspect include corresponding systems, apparatus, and computer programs, configured to perform the actions of the methods, encoded on computer storage devices.

These and other implementations can each optionally include one or more of the following features: performing an action comprises: in response to determining that at least one of the first candidate demands has not been processed, selecting one of the at least one of the first candidate demands for reassigning time-limited resources with the particular demand; performing an action comprises: in response to determining that all of the first candidate demands have been processed, identifying, for each of the first candidate demands, one or more second candidate demands in the assignment plan, each second candidate demand and associated time-limited resources satisfying one or more second constraints defined by the respective first candidate demand and associated time-limited resources; the actions further comprise determining that at least one of the second candidate demands for the first candidate demands has not been processed and selecting one of the at least one of the second candidate demands for reassigning time-limited resources with the respective first candidate demand and the particular demand; the event can be cancelling the particular demand from the assignment plan, and reassigning time-limited resources with the respective first candidate demand and the particular demand comprises: reassigning the particular time-limited resources for the particular demand to the respective first candidate demand and reassigning the time-limited resources for the respective first candidate demand to the selected second candidate demand; the one or more constraints defined by the particular demand and associated particular time-limited resources comprise at least one of: a resource type of associated time-limited resources for the first candidate demand being same as a resource type of the particular time-limited resources, associated time-limited resources for the first candidate demand having not arrived at a demander associated with the first candidate demand when the event occurs, or the particular time-limited resources being in lifetime when the particular time-limited resources arrive at the demander associated with the first candidate demand; the actions further comprise: building a hierarchical graph model by repeatedly identifying one or more candidate demands for proceeding demands in the assignment plan, the changed demand being the first proceeding demand, and determining an optimal reassignment plan by searching the hierarchical graph model based on a cost function; the optimal reassignment plan includes least times of reassignment implementation.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example supply-demand system in accordance with implementations of the present disclosure.

FIG. 2 depicts an example scheduling system in accordance with implementations of the present disclosure.

FIG. 3A depicts an example process that can be executed in accordance with implementations of the present disclosure.

FIG. 3B depicts an example process that can be executed in accordance with implementations of the present disclosure.

FIG. 4 depicts an example reassignment graph in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are generally directed to event-triggered reassignment of time-limited resources. More particularly, implementations of the present disclosure are directed to dynamically reassigning time-limited resources for demands in response to unexpected events (e.g., demand changes such as demand cancelling or adding). In some examples, time-limited resources include resources that are no longer usable after a period of time (e.g., resources that spoil). That is, time-limited resources include resources that become obsolete after a period of time.

In some implementations, dynamic event-triggered demand changes are treated as individual snapshots of a one-one mapping between a queue of demand and a queue of supply (e.g., time-limited resources) at the moment of an event occurrence. In some examples, all the possible resource reassignments can be represented as a hierarchical graph, where hierarchy is used to represent cause-effect relation of each resource reassignment. In some examples, a feasible solution with minimal cost (e.g., the solution with least number of reassignments) is searched by a searching algorithm. In some examples, the event-triggered resource reassignment includes multiple steps: 1) update of demands: find a queue of demand and a queue of supply with respect to one event snapshot; 2) graph modeling of reassignment: build a hierarchical graph model to show cause-effect of each possible reassignment; 3) optimization: find the minimal cost solution by searching the graph model.

In some implementations, the event-triggered resource reassignment is performed by iteratively searching. In some examples, a scheduling system can identify one or more candidate (or alternative) demands for the changed demand in the queue of demand. Each candidate demand and associated time-limited resources satisfy one or more constraints defined by the changed demand and associated time-limited resources. In some examples, the scheduling system can determine whether at least one of the candidate demands has not been processed (e.g., the associated time-limited resources have not been prepared and/or produced).

In some examples, if at least one of the candidate demands has not been processed, the scheduling system can select one of the unprocessed candidate demands and reassign time-limited resources for the changed demand to the unprocessed candidate demand, or time-limited resources for the unprocessed candidate demand to the changed demand. In some examples, if all of the candidate demands have been processed, the scheduling system continues to search one or more second candidate demands for each candidate demand of the changed demand. In some examples, the scheduling system determines whether at least one of the second candidate demands has not been processed. By iteratively searching, the scheduling system can quickly find a feasible solution (e.g., one with least number of resource reassignments.

Implementations of the subject matter described in this specification can be used to realize one or more advantages. A scheduling system can harness the time-limited resources reassignment to avoid waste/loss when demand changes. The scheduling system can achieve an optimal reassignment solution with minimal cost and minor influence to global demand and/or delivery scheduling. The scheduling system can transform the complex assignment process with chain reaction into graph searching problem. The scheduling system can schedule all the demands in the same time and/or schedule demands associated with different types of time-limited resources. The scheduling system can consider potential chain reaction of production changes, demand changes, or delivery changes (e.g., truck route changes).

Implementations of the present disclosure will be described in further detail with reference to an example context. The example context is directed to an example time-limited resource. In some examples, a time-limited resource includes resources that are no longer usable after a period of time (e.g., resources that spoil). That is, a time-limited resource includes resources that become obsolete after a period of time. In building construction, for example, ready-mixed concrete needs to be produced and transported from a supplier (e.g., a production center) to one or more demanders (e.g., construction areas). Each demander can specify expected delivery time, at which the concrete should be delivered to the respective construction site. However, because it is a time-limited resource, the concrete should be consumed (e.g., used) within a limited period of time (e.g., 2 hours) after production to keep its validity. Otherwise, the concrete would become obsolete. Accordingly, the concrete should be scheduled and prepared beforehand and delivered to the construction areas in-time.

Although implementations of the present disclosure are described in further detail herein with reference to delivery and consumption of concrete, it is contemplated, that implementations of the present disclosure can be used in any appropriate context, and with any appropriate time-limited resource.

In some implementations, example demands and time-limited resources include one or more of the following example features: resources take limited life cycle, which is short and compatible to delivery time to a demander; resource preparation and scheduling can be completed before the delivery and the time cost is cannot be neglected; the resource preparation process is irreversible (e.g., when the preparation or production is started, it can't be cancelled, but, if the preparation or production has not begun, the order can be cancelled and rescheduled); demand requests take constraints of delivery time where a short time-delay is allowed; and/or demand changes unexpectedly. As discussed in further detail herein, requested resources could be reassigned to others with constraints of resource validity and response promptness.

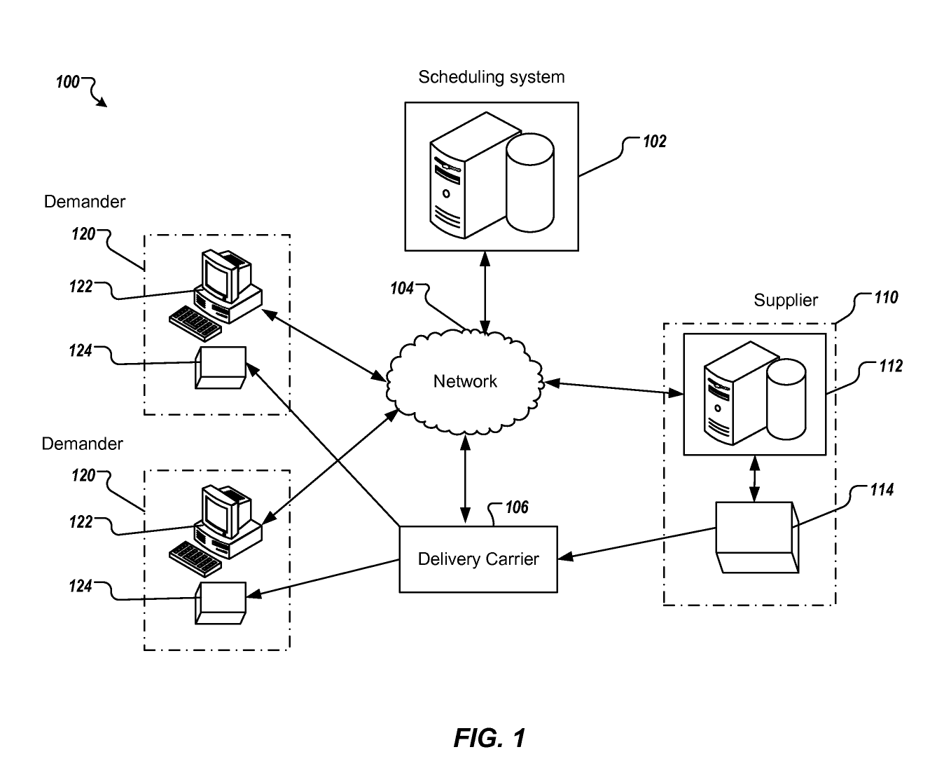

FIG. 1 depicts an example supply-demand system 100 in accordance with implementations of the present disclosure. The system 100 includes a scheduling system 102, a supplier 110 and one or more demanders 120. The supplier 110 can provide time-limited resources to the demanders 120 according to demands or orders from the demanders 120. The scheduling system 102 can schedule (or assign) a number of demands with a number of time-limited resources and/or reschedule (or reassign) the number of time-limited resources for the number of demands in response to demand changes.

In some examples, the supplier 110 can be associated with a supply computing system 112 and a supply facility 114. The supply facility 114 provides one or more types of time-limited resources (e.g., concrete). For example, the supply facility 114 can be a production center for preparing and/or producing time-limited resources. The supply computing system 112 receives demands or orders from the demanders 120. The supply computing system 112 can also communicate with the supply facility 114 (e.g., transmitting the demands to the supply facility 114 and/or collecting status information on whether the time-limited resources for the demands have been prepared, produced, and/or delivered). In some implementations, the scheduling system 102 is operated by the supplier 110 (e.g., is included in the supply computing system 112).

In some implementations, the scheduling system 102 is in a distributed computing system (e.g., a cloud server) and provides scheduling and/or rescheduling services. For example, the scheduling system 102 can be a central scheduling system for a number of suppliers and demanders including the supplier 110 and the demanders 120. In some examples, each supplier 110 can be associated with one or more supply facilities for providing one or more different types of time-limited resources. In some examples, the demanders 120 directly submit demands to the scheduling system 102, and the scheduling system 102 schedules and/or reschedules the demands to corresponding suppliers 110 for corresponding time-limited resources. In some examples, each supplier conveys received demands from the demanders 120 to the scheduling system 102, and the scheduling system 102 schedules and/or reschedules the received demands for the individual supplier. In some examples, when the received demands exceed the capacity of the contacted supplier, the scheduling system 102 can redirect at least a portion of the demands to other suppliers (e.g., per request of the contacted supplier).

In some examples, each demander 120 can be associated with a demand computing system 122 and a demand facility 124. A demander 120 can send demands or orders (e.g., by using a demand computing system 122) through a network 104. In some examples, the network 104 can include a large computer network, such as a local area network (LAN), a wide area network (WAN), the Internet, a cellular network, or a combination thereof connecting any number of mobile computing devices, fixed computing devices and server systems. In some examples, the demander 120 can also, or alternatively, send the demands or orders by mail, fax, phone or in-person.

The scheduling system 102, the supply computing system 112, or the demand computing system 122 can include any appropriate type of device such as a tablet computing device, a handheld computer, a mobile device, a personal digital assistant (PDA), a cellular telephone, a network appliance, a camera, a smart mobile phone, an enhanced general packet radio service (EGPRS) mobile phone, a media player, a navigation device, a game console, or any appropriate combination of any two or more of these data processing devices or other data processing devices.

After production, the time-limited resources can be delivered from the supply facility 114 to the demand facility 124 using one or more delivery carriers 106. Although a single delivery carrier 106 is depicted in the example of FIG. 1, time-limited resources can be conveyed using one or more delivery carriers (e.g., trucks, trains, boats, airplanes, drones). The demander 120 can specify expected delivery time. That is, the time-limited resources should be delivered to the demander at the expected delivery time, while still being in its validity period. The delivery carrier 106 can also communicate to other computing systems over the network 104. For example, the delivery carrier 106 can update traffic or delivery status to the scheduling system 102 and/or the supply computing system 112 and/or the demand computing system 122.

The scheduling system 102 can be configured to schedule an assignment plan for assigning a number of demands from the demanders 120 to a number of time-limited resources from the supplier 110 and/or other suppliers. The scheduling system 102 can obtain information of the demands (including sudden demand changes) from the demanders 120 directly and/or from the supplier 110, information of the time-limited resources from the supplier 110, traffic information, and/or delivery information (e.g., from the delivery carrier 106). Based on the obtained information, the scheduling system 102 can dynamically reassign the time-limited resources for the demands (e.g., including preparation/production schedule and/or delivery schedule), as described in further detail herein.

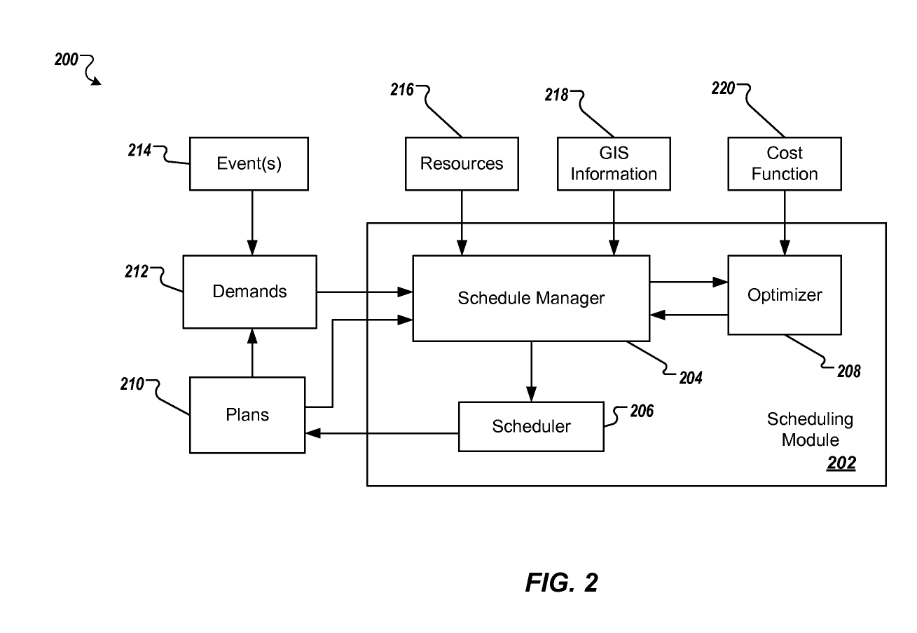

FIG. 2 depicts an example scheduling system 200 in accordance with implementations of the present disclosure. In some examples, the scheduling system 200 can be provided by the scheduling system 102 of FIG. 1. In the depicted example, the scheduling system 200 includes a scheduling module 202, a plan repository 210, a demand module 212, an event module 214, a resource module 216, a Geographic Information System (GIS) module 218, and a cost function module 220. The scheduling module 202 can include a schedule manager 204, a scheduler 206 and an optimizer 208. In some examples, the scheduling system 200 can be provided as one or more computer-readable memories (e.g., data stores), and one or more computer-executable programs executed by one or more computing devices.

In some examples, the plan repository 210 stores an assignment plan. The assignment plan can be an initial plan including a number of demands associated with a number of time-limited resources. In some examples, the initial plan can be scheduled statically by a scheduler (e.g., the scheduler 206). For each demand, the assignment plan can include schedule information for the associated time-limited resources (e.g., when to be prepared/produced and when to be delivered). If there is no unexpected event (e.g., no demand change, no time-limited resource change and/or no delivery change), the supplier can follow the initial plan to produce and deliver the time-limited resources to the demanders. If an event occurs (e.g., demand changes), the scheduling system 200 can dynamically update or reschedule the assignment plan to accommodate the changed demand, as described in further detail herein.

In some examples, the event module 214 receives events from demanders (e.g., the demanders 120 of FIG. 1), or from the supplier (e.g., the supplier 110 of FIG. 1). For example, a demander can send a notification to change a demand (e.g., to cancel a demand, to add a new demand, to cancel an old demand and add a new demand, or to change information of a demand such as expected delivery time). In some examples, the demander sends the notification of demand change directly to the scheduling system 200. In some examples, the demander sends the notification of demand change to the supplier 110, which forwards the notification to the scheduling system 200. The event module 214 sends the event (e.g., the notification of demand change) to the demand module 212.

In some implementations, the demand module 212 receives, stores, and/or updates demands from one or more demanders (e.g., the demander 120 of FIG. 1) from a supplier (e.g., the supplier 110 of FIG. 1), and/or from the plan repository 214. When the demand module 212 receives an event from the event module 214, the demand module 212 can process the notification of demand change and determine the changed demand and/or associated time-limited resources scheduled or prepared for the changed demand. For example, if the event is to cancel a Demand X, the changed demand is determined to be the Demand X. If the event is to add a new demand, Demand X, the changed demand can be determined to be the Demand X. The demand module 212 can update a list of demands stored in the demand module 212 with the changed demand and/or associated time-limited resources and provide the updated list of demands to the schedule manager 204 for reassignment.

In some implementations, the demand module 212 stores the list of demands in categories. For example, the demands can be stored separately by expected delivery dates. When the demand module 212 determines the changed demand, the demand module 212 can find a queue of demands that have the same expected delivery date as the changed demand, update the queue of demands with the changed demand and provide the updated queue of demands to the schedule manager 204 for reassignment.

In some implementations, the demand module 212 receives or retrieves an assignment plan from the plan repository 210. The demand module 212 can retrieve the current demands and/or time-limited resources from the assignment plan and update the current demands and/or time-limited resources with the changed demand and/or associated time-limited resources.

In some examples, the plan repository 210 stores a number of assignment plans in categories (e.g., by days, by locations, and/or by types of time-limited resources). For example, the plan repository 210 can include a first assignment plan for Day 1 and a second assignment plan for Day 2. The demand module 212 can retrieve a particular assignment plan based on the received event or the changed demand. For example, if the changed demand has an expected delivery date on Day 2, the demand module 212 retrieves demands and/or time-limited resources from the second assignment plan, and updates the retrieved demands and/or time-limited resources with the changed demand and/or associated time-limited resources.

In some implementations, the scheduling module 202 is configured to schedule or reschedule time-limited resources for demands. The schedule manager 204 receives an updated list of demands from the demand module 212. The schedule manager 204 can obtain information of time-limited resources from the resource module 216. The resource information can include a resource type, cost of one unit of resource, time to produce resource, life time of the produced resource.

In some examples, the resource module 216 receives real-time information from the supplier or a supply facility associated with the supplier (e.g., the supply facility 114 of FIG. 1). The real-time information can include when a time-limited resource for a demand is prepared, produced, and/or delivered.

In some examples, the schedule manager 204 can receive GIS information from the GIS module 218. The GIS information includes transportation time from the supplier (e.g., the supply facility) to a demander associated with a demand. In some examples, the GIS module 218 collects real-time traffic information for each demand based on the transportation route from the supplier to the demander.

Based on the collected information, including the updated list of demands, updated information of time-limited resources, and/or the updated GIS information, the schedule manager 204 can look for a feasible solution for resource reassignment in response to the occurrence of an event. In some examples, the feasible solution can be a solution with minimal cost (e.g., with least times of reassignment implementations or with minimal influence to other production and/or delivery plans). As discussed in further detail below, the schedule manager 204 can find an optimal solution by iteratively searching candidate demands and determining whether the candidate demands have not been processed, or by building a hierarchy graph model to show cause-effect of each possible reassignment and then searching the hierarchy graph model with a cost algorithm, or by a combination thereof.

When the schedule manager 204 finds two or more possible reassignment plans, the schedule manager 204 can send information on the possible reassignment plans to the optimizer 208. The optimizer 208 is configured to find out an optimal reassignment plan from the possible reassignment plans. In some implementations, the cost function module 220 provides a cost function for assigning costs to respective reassignment plans. In some examples, the cost function can be specified by a customer (e.g., by the supplier).

In some implementations, the schedule manager receives the reassignment plans and respective costs. In some examples, the schedule manager 204 determines that the reassignment plan with the minimal cost is the optimal reassignment plan. The schedule manager 204 can output the optimal reassignment plan to the scheduler 206. The scheduler 206 can reassign all the demands and time-limited resources based on the optimal reassignment plan to provide a new assignment plan. The scheduler 206 can provide the new assignment plan to the plan repository 214. The plan repository 214 can make the new assignment plan as the latest assignment plan, replacing a previous assignment plan (e.g., the initial assignment plan), and time-limited resources are produced and/or delivered based on the latest assignment plan. When another event occurs, the demand module 212 can retrieve the latest assignment plan from the plan repository 214, and can develop another reassignment plan in response to the event.

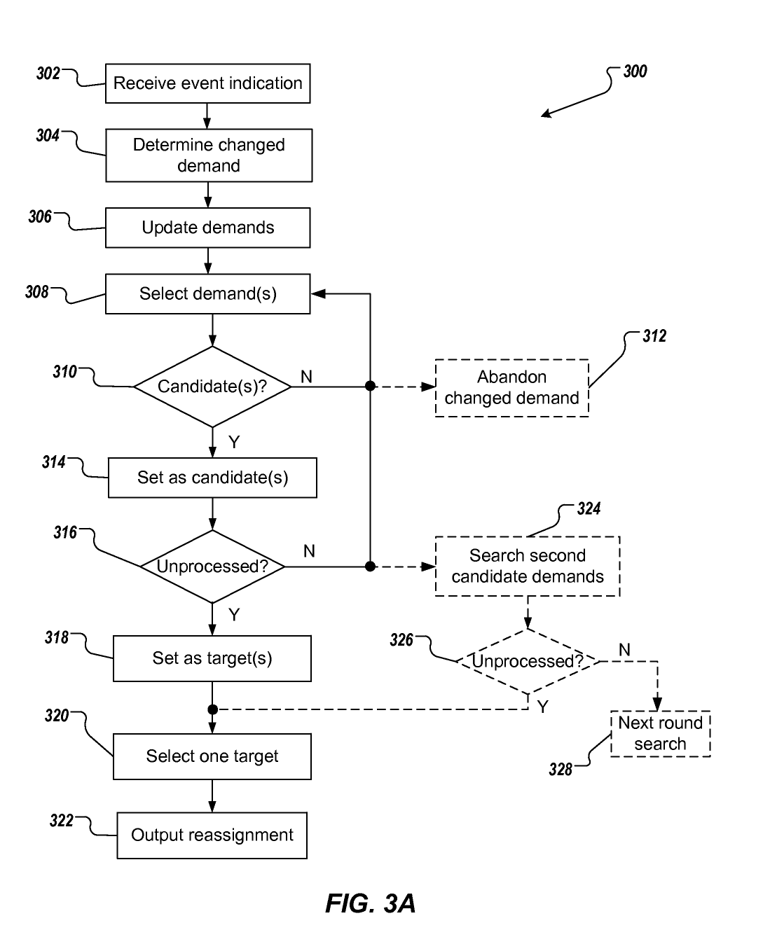

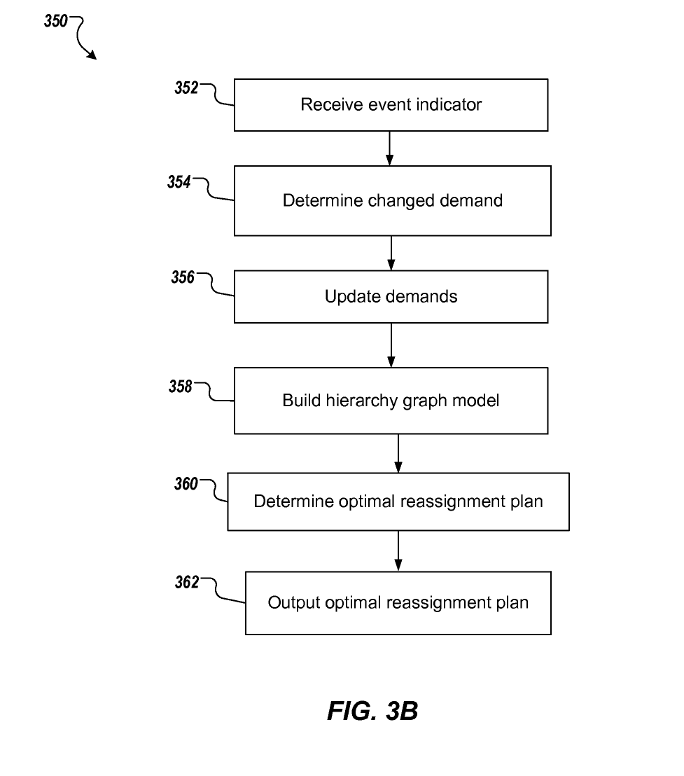

FIG. 3A depicts an example process 300 that can be executed in accordance with implementations of the present disclosure. In some examples, the example process 300 can be provided by one or more computer-executable programs executed by one or more computing devices. For example, the process 300 can be performed by a scheduling system (e.g., the scheduling system 200 of FIG. 2). In some examples, the process 300 includes iteratively searching, as described herein.

An event indication is received (302). For example, a demander can cancel a demand. Consequently, the demander can provide an event indication reflecting the changed demand. The demander or a supplier receiving the demand can provide the event indication to the scheduling system. A changed demand is determined (304). For example, the scheduling system can process the event to determine the changed demand and/or associated time-limited resources. A list of demands is updated (306). For example, and as discussed above, a demand module (e.g., the demand module 212 of FIG. 2) can retrieve the list of demands from an assignment plan based on the changed demand, and can update the list of demands with the changed demand and/or associated time-limited resources.

One or more demands in the updated list is selected (308), and it is determined whether the one or more demands are candidate demands (310). For example, the scheduling system can search the updated list of demands to determine one or more candidate demands for the changed demand. In some examples, a candidate demand means that, when a demand is cancelled, time-limited resources of the cancelled demand can be reassigned to the candidate demand to replace the cancelled demand. In some examples, a candidate demand means that, when a demand is added, time-limited resources for the candidate demand can be reassigned to the added demand.

The scheduling system can determine whether a demand is a candidate demand for the changed demand by determining whether the demand and/or associated time-limited resources is satisfied with one or more constraints (or conditions) defined by the changed demand and/or associated time-limited resources. In some examples, the one or more constraints can include: a resource type of associated time-limited resources for the demand is the same as a resource type of the associated time-limited resources for the changed demand; associated time-limited resources for the demand have not arrived at the associated demander when the event occurs; and/or the time-limited resources of the changed demand are in their lifetime when the time-limited resources arrive at a demander associated with the demand.

If the scheduling system determines that a demand is not a candidate demand, the scheduling system continues to check another demand in the updated list of demands. In some examples, the scheduling system determines that there is no candidate demand for the changed demand in the updated list of demands. If the changed demand is a cancelled demand, the scheduling system can abandon the time-limited resources for the changed demand and keep the assignment plan for other demands (312).

If the scheduling system determines that the chosen demand is a candidate demand, the scheduling system can optionally set the chosen demand to be a candidate demand (314). In some implementations, the scheduling system further determines whether the candidate demand, e.g., associated time-limited resources for the candidate demand, has been processed (316), e.g., by a supplier.

If the scheduling system determines that the candidate demand has been processed, the scheduling system continues to check another demand in the updated list of demands. If the scheduling system determines that the candidate demand has not been processed, the scheduling system can optionally set the unprocessed candidate demand to be a target demand for reassignment (318). In some implementations, the scheduling system selects the unprocessed candidate demand for reassignment without further searching.

In some implementations, the scheduling system chooses each demand in the updated list of demands to determine whether the demand is a candidate demand for the changed demand and determine whether each candidate demand has been processed. If at least one candidate demand has not been processed (e.g., there is at least one target demand), the scheduling system can select one of the at least one target demand for reassignment (320).

In some examples, the scheduling system randomly selects one from the at least one target demand. In some examples, the scheduling system selects one with minimal cost (e.g., by using the optimizer 208 of FIG. 2). For example, a target demand with closer expected delivery time and/or closer delivery locations to those of the changed demand than other target demands can be selected for reassignment.

A reassignment plan is output (322). The scheduling system can use the selected target demand for reassignment. For example, if the changed demand is a cancelled demand, the scheduling system can reassign time-limited resources of the changed demand to the selected target demand and keep the assignment plan for other demands.

If all the candidate demands for the changed demand in the updated list of demands have been processed, the scheduling system can go to a second round search to determine second candidate demands for each of the candidate demands in the updated list of demands (324). Similarly, for each candidate demand of the changed demand, the scheduling system can determine whether a demand in the updated list of demands is a second candidate demand for the candidate demand and further determine whether the second candidate demand has been not processed (326).

If at least one of the second candidate demands of the candidate demands has not been processed, the scheduling system can select one of the at least one of the at least one unprocessed second candidate demand for reassignment (320) (e.g., by using the optimizer 208 of FIG. 2 to determine an optimal reassignment plan with minimal cost from all the possible reassignment plans each including the corresponding unprocessed second candidate demand).

The scheduling system outputs the reassignment plan (322) using the selected unprocessed second candidate demand. For example, if the changed demand is a cancelled demand, the scheduling system can reassign the time-limited resources of the changed demand to the respective candidate demand and reassign the time-limited resources of the respective candidate demand to the selected unprocessed second candidate demand. Other demands in the assignment plan can be kept without reassignment.

If all the second candidate demands of all the candidate demands of the changed demand have been processed, the scheduling system goes to a third round search by determining third candidate demands for each second candidate demand determined in the second round search (328). The scheduling system can stop searching when at least one nth candidate demand in an nth round search is unprocessed, where n is an integer.

FIG. 3B depicts an example process 350 that can be executed in accordance with implementations of the present disclosure. In some examples, the example process 350 can be provided by one or more computer-executable programs executed by one or more computing devices. For example, the process 350 can be performed by a scheduling system (e.g., the scheduling system 200 of FIG. 2). In some examples, the process 350 includes building a hierarchical graph model.

After receiving an event indicator (352), determining a changed demand (354) and updating a list of demands (356), the scheduling system builds a hierarchical graph model (358). In some implementations, the scheduling system builds the graph model by repeatedly searching candidate demands for proceeding demands in the updated list of demands. For example, the scheduling system can determine first candidate demands for the changed demand in a first round search, can determine second candidate demands for each first candidate demand in a second round search, and so on.

In some examples, the scheduling system stops searching when at least one nth candidate demand in an nth round search is unprocessed, where n is an integer. Each reaction chain starting from the changed demand to one of the at least one nth candidate demand represents a possible reassignment plan. In some examples, the scheduling system stops searching when there are no more candidate demands found in the updated list of demand in a following round search. The scheduling system builds the hierarchical graph model by connecting proceeding demands and associated candidate demands in each reaction chain.

An optimal reassignment plan is determined (360) and is output (362). The scheduling system can use an optimizer (e.g., the optimizer 208 of FIG. 2) to determine the optimal reassignment plan. The optimizer can use a cost function to find the optimal reassignment plan with minimal cost (e.g., by searching the graph model to identify one with least times of reassignment implementations).

A particular implementation of the present disclosure is described below.

TABLE 1
Variable Parameters

| Variable name | Notation | Remark |
|---|---|---|
| Resource type | k | k = 1, 2, . . . , K |
| Demander id | j | j = 1, 2, . . . , J |
| Cost of one unit of resource | vₖ | Appears in cost function when it is discarded |
| Time to produce resource k | Tₖ | Consider the preparation of one unit of |
| | | resource |
| Life time (period of validity) | Lₖ | Consider the preparation of one unit of |
| of resource k | | resource |
| Remaining lifetime | Lₖ(t) | At time t, the remaining lifetime of a specific |
| | | resource. For example, if it is produce at t₀, |
| | | then Lₖ(t) = Lₖ − (t − t₀) |
| Traffic time from the supplier | Tⱼ | Traffic cost is in general a very small part of |
| to the j^{th} demander | | the total costs, hence is omitted. |
| Demand of resource with | Dₜ | A set of demands, each of which is defined |
| allowance of delay | | by: at scheduled delivery time t, demander j |
| | | requires a unit of resource k, with an |
| | | allowance of delivery delay Δ. |
| Event at time t | Eₜ | Change of Demand: D_{j, k, t}, Δ_{j, k, t} [symbol] D′_{j, k, t}, Δ′_{j, k, t} |
| | | Change of Supply: S_{k, t} [symbol] S′_{k, t} |
| Scheduled preparation of | Sₜ | At time t, the supplier starts to produce a |
| resources | | unit of resource k, with an allowance of |
| | | delivery delay |
| Assignment of resources | Aₜ | A is a one-one mapping which assign each |
| | | element in {Sk, t} to each element in {Dj, k, t}, |
| | | that try to fulfill all demands from |
| | | demanders. |
| Reassignment | {Pₜ₊} | the set of all rescheduled plans |
| Cost function of | V(Pₜ_{⁺}, Pₜ_{^{−}}) | The cost includes |
| Reassignment | | 1) ck, by any inevitable discard of Sk, t |
| | | 1) cr, base 1/adefnprsvx yielded by each |
| | | reassignment |
| Optimal Reassignment | Pₜ_{⁺}* | |

For illustration, and with reference to the example context introduced above, an example time-limited resource is concrete. In some examples, it is assumed that a (concrete) supplier is responsible for the time-limited resource (concrete) supply Rₖ, k=1, 2, . . . , K to the multiple demanders (construction sites) Dⱼ, j=1, 2, . . . , J.

A production schedule can be made for the supplier, according to demands (or orders) of resources from all demanders. In some examples, the supplier is assumed to have infinite producing capacity. Therefore, any static planning can meet all the demands. While considering the dynamic changes to the demands/supplies, the scheduled plan can also adapt to these changes. A snapshot of the dynamic plan can be described as a one-one mapping from the resources in the queue of preparation process to the queue of demands.

A time period can be considered for the scheduling, which can be selected as the working hour of a day, denoted as [tb, te], specified by its beginning (b) and end (e). The supplier can collect the orders of resources from each demander (j=1, 2, . . . , J; k=1, 2, . . . , K; t E [tb, te]. These conditions are omitted in the following text:

Dₜ_{_{b}}:{Dₜ_{_{b}}_{,j}}={{d(j,k,t,Δ)}}

where the order is required to be delivered to Dⱼ at time t, with an allowance of delay Δ. In some examples, the supplier can generate a production schedule according to Dₜ_{_{b}}, at the very beginning of the day.

In some implementations, the initial schedule is split into two parts. First, the queue of production of resources is arranged as: Sₜ_{_{b}}: {s(k,t)}. Second, the mapping from Sₜ_{_{b}} to Dₜ_{_{b}} forms a set of pairs:

Aₜ_{_{b}}:{(s(kₛ,tₛ),d(j,k_{d},t_{d},)),s(kₛ,tₛ)εSₜ_{_{b}},d(j,k_{d},t_{d},Δ)εDₜ_{_{b}}}

where each element assigns a unit of resource from the supplier to one demander. In some examples, the mapping is constrained by the condition for each s(kₛ,tₛ) εSₜ_{_{b}},d(j,k_{d},t_{d},Δ)εDₜ_{_{b}}. The type of resource matches the demand: kₛ=k_{d}. Resource is delivered in time: tₛ+Tₖ Tⱼ≦t_{d}+Δ. Resource is delivered in its life time: Tₖ Tⱼ≦Lₖ, and the amount of resources in Sₜ_{_{b}} equals to the total amount of resources in Dₜ_{_{b}}. Accordingly, the initial schedule is planned as: Pₜ_{_{b}}:(Sₜ_{_{b}},Aₜ_{_{b}}), which is a planning of a static production schedule and can be considered as the initialization of the dynamic scheduling process.

The demands and supplies can inevitably change at any time due to any reason. For simplicity, the change is uniformly denoted by an event of demand change at the time t: Eₜ:{d(j,k,t,Δ) [symbol] d′(j,k,t,Δ)}. In some examples, the events include an order d(j,k,t,Δ) being canceled or an additional order being raised, which are d(j,k,tΔ) [symbol] 0, or 0 [symbol] d(j,k,t,Δ), respectively, where “0” denotes a virtual “zero demand.” Any change in supply can be transformed to a problem of demand change, since in the above-defined scheduling, the mapping of supply/demand is one-one.

When an event occurs at time t, a rescheduling to the working production plan is triggered. Compared to the previous plan Pₜ_{^{−}}, all possible rescheduling plans are defined by {Pₜ_{⁺}}, which is provided as the set of all rescheduled plans. The aim is to find out the optimal Pₜ_{⁺}^{o}, which is provided as the reassignment (reschedule) plan having the least cost. This is achieved using the cost function, as described in detail herein. In some implementations, the rescheduled plan is given by: Pₜ_{⁺}:(Sₜ_{⁺},Aₜ_{⁺}).

In some implementations, the cost function is provided as the following example relationship:

$$V ( {P}_{{t}^{+}} , {P}_{{t}^{-}} ) = {\sum }_{k , t ∈ {S}_{{t}^{-}}} [ {υ}_{k} \cdot DIS ( {P}_{{t}^{+}} , s ( k , t ) ) ] + {c}_{r} \cdot NR ( {P}_{{t}^{+}} , {P}_{{t}^{-}} )$$

where DIS(Pₜ_{⁺},s(k,t)) denotes bool value judging s(k,t) is discarded in Pₜ_{⁺}, NR the total times of unit resource reassignment.

The following tables provide descriptions for modules in the scheduling system.

TABLE 2
Resources T_{R}

| COLUMN NAME | DESCRIPTION |
|---|---|
| RESOURCE TYPE | k = 1, 2, . . . , k |
| COST OF ONE UNIT OF RESOURCE | Appears in cost function |
| | when it is discarded |
| TIME TO PRODUCE RESOURCE k | Consider the preparation |
| | of one unit of resource |
| LIFE TIME (PERIOD OF VALIDITY) | Consider the preparation |
| | of one unit of resource |
| OF RESOURCE k | |

TABLE 3
Function of Transportation T(i, j)

| COLUMN NAME | DESCRIPTION |
|---|---|
| TRAFFIC TIME | Implemented and calculated in real |
| BETWEEN ANY TWO | time on the map by solving the |
| POINTS ON A MAP | shortest path problem. |
| T(I, J) | |

TABLE 4
GIS Information T_{T}

| COLUMN NAME | DESCRIPTION |
|---|---|
| TRANSPORTATION TIME | T(0, j), where 0 denotes the supplier |
| FROM THE UPPLIER | |
| TO THE J-TH DEMANDER | |

TABLE 5
Demand table T_{D}

| COLUMN NAME | DESCRIPTION |
|---|---|
| DEMANDER ID | j = 1, 2, . . . , J |
| RESOURCE TYPE | k = 1, 2, . . . , K |
| REQUIRED DELIVERY TIME | t |
| ALLOWANCE OF DELIVERY DELAY | Δ ≧ 0 |

TABLE 6
Demand change table (or event table) T_{E}

| COLUMN NAME | DESCRIPTION |
|---|---|
| EVENT AT TIME t | Change of Demand: D_{j, k, t}, Δ_{j, k, t} [symbol] D′_{j, k, t}, Δ′_{j, k, t} |

TABLE 7
Production schedule table T_{S}

| COLUMN NAME | DESCRIPTION |
|---|---|
| RESOURCE TYPE | k = 1, 2, . . . , K |
| PRODUCTION TIME | start to produce resource at time t |
| DEMANDER ID | j = 1, 2, . . . , J |

TABLE 8
Intermediate Tables {T_{S}}

| COLUMN NAME | DESCRIPTION |
|---|---|
| CANDIDATE | {T_{S}} the set of all rescheduled plans |
| REASSIGNMENT SET | |
| COST FUNCTION | V(Pₜ_{⁺}, Pₜ_{^{−}}) calculated by solver in real-time |
| OF REASSIGNMENT | |

TABLE 9
Output Tables T_{S}*

| COLUMN NAME | DESCRIPTION |
|---|---|
| RESOURCE TYPE | k = 1, 2, . . . , K |
| PRODUCTION TIME | start to produce resource at time t |
| DEMANDER ID | j = 1, 2, . . . , J |

In accordance with implementations of the present disclosure, the above-discussed rescheduling problem can be solved by constructing a directed graph in a breadth-first way. In some examples, the vertices in the graph are orders from demanders, and, if the constraints are satisfied, the vertex of order d(i,kᵢ,tᵢ,Δᵢ) has a directed edge pointing to the vertex of order d(j,kⱼ,tⱼ,Δⱼ), meaning that when a demand change occurs, the order d(i,kᵢ,tᵢ,Δᵢ) of demander i can be reassigned to demander j to replace the order d(i,kⱼ,tⱼ,Δⱼ). That is, demander j is a candidate demand of demander i.

In some implementations, it is provided that a demand change occurs at time t. Example conditions include:

(1) The indicator function I(dⱼ,t)=1, meaning that the resource of order d(j,kⱼ,tⱼ,Δⱼ) has not arrived at demander j at time t.
(2) kᵢ=kⱼ, i.e., the resource type of the two orders should be the same.
(3) tⱼε[t+Tᵢⱼ−Δⱼ,t+Lₖ], where Tᵢⱼ is the time cost for shipping the resource of d(i,kᵢ,tᵢ,Δᵢ) to demander j. Here tⱼ≧t+Tᵢⱼ−Δⱼ ensures that the resource of order d(i,kᵢ,tᵢ,Δᵢ), if shipped to demander j, can arrive at demander j before the scheduled delivery time of demander j plus the allowed delay, and tⱼ≦t+Lₖ ensures that the resource is still in the lifetime when it arrives at demander j.

In some examples, it is assumed that the order d0 is cancelled. In response, and in some examples, the scheduling system can perform the following example steps:

(1) Set d0 as a starting vertex;
(2) Among the vertices that have not been considered previously, find all the vertices that starting vertices (there can be more than one starting vertex) can have an edge pointing to (please refer to the above conditions); If no vertices can be found, go to step (4);
(3) For vertices found in step (2):

(a) If there is a vertex of which the demander's order has not been processed by the supplier, the path from d0 to this vertex is the desired reaction chain (note that there may be several such vertices, take any one). Return the path.

(b) else, set all the vertices found in the previous step as starting vertices, go to step (2);

(4) If no results are returned in (3)(a) and no new vertices can be further found in (2), the process ends. Abandon the resource prepared for d0, and keep the plan for other orders.

In some implementations, pseudo-code of the above-described steps can be provided. The inputs of the function include d0, which is the cancelled order that triggered a demand change, and t, which is the time when demand change occurs.

```
  FUNCTION Reassignment(d0, t)
  StartingVertices = <d0>;
  VerticesToBeConsidered = D0 \ d0; // D0 means all the original orders
  WHILE VerticesToBeConsidered is NOT empty
    NewStartingVertices = < >;
      FOR each d(i,kᵢ,tᵢ,Δᵢ) in StartingVertices
        FOR each d(j,kⱼ,tⱼ,Δⱼ) in VerticesToBeConsidered
            VerticesToBeConsidered = VerticesToBeConsidered \
d(j,kⱼ,tⱼ,Δⱼ);
            IF I(dⱼ,t) = 1 and kᵢ = kⱼ and
tⱼε[t + Tᵢⱼ − Δⱼ,t + Lₖ]
              Point d(i,kᵢ,tᵢ,Δᵢ) to d(j,kⱼ,tⱼ,Δⱼ);
              IF d(j,kⱼ,tⱼ,Δᵢ) has not been processed by the
supplier
                Return Path(d0−>d(j,kⱼ,tⱼ,Δⱼ);
              ELSE
                NewStartingVertices =
<NewStartingVertices, d(j,kⱼ,tⱼ,Δⱼ)>;
              END IF
            END IF
        END FOR
      END FOR
      IF NewStartingVertices is empty
          Abandon the resource of d0, keep the plan for other orders;
          Return;
      END IF
      StartingVertices = NewStartingVertices;
  END WHILE
  // No reaction chain can be found
  Abandon resource of d0, keep the plan for other orders;
  Return;
  END FUNCTION
```

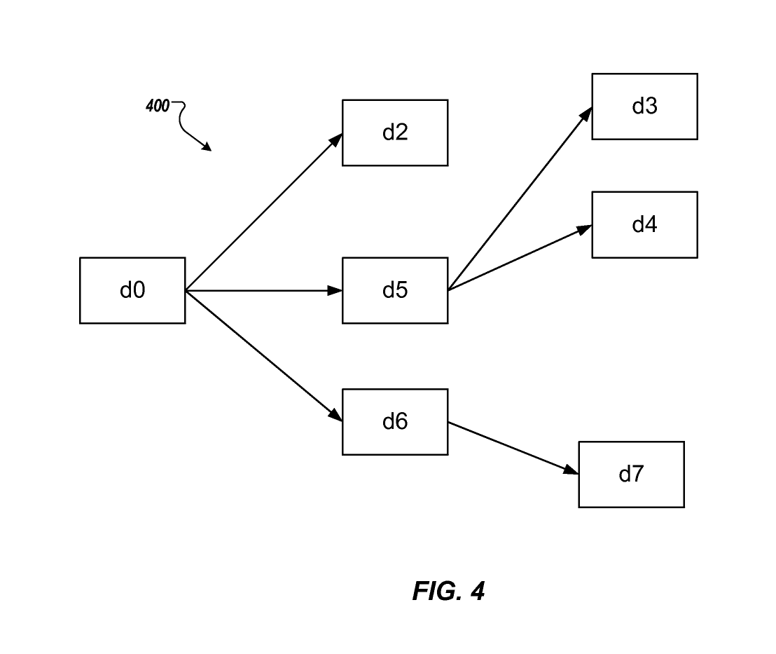

FIG. 4 depicts an example directed graph 400 in accordance with implementations of the present disclosure. The directed graph 400 can be provided by a scheduling system (e.g., the scheduling system 200 of FIG. 2).

The vertex d0 in the graph 400 is an order that triggered a demand change. The changed demand d0 has three edges pointing to d2, d5 and d6 respectively, where d2, d5 and d6 are candidate demands of the changed demand. In this example, because the candidate demands d2, d5 and d6 have all been processed by a supplier, the scheduling system proceeds to a next iteration (e.g., a next round of search). As illustrated in the reassignment graph 400, second candidate demands d3, d4 and d7 are vertices found by setting d2, d5 and d6 as new starting vertices, and among these three vertices, d3 has not been processed by the supplier. In some examples, it is determined that d0->d5->d3 is an optimal resource reassignment chain (e.g., it has a minimal cost among potential reassignment chains). Accordingly, the demand change can be resolved by reassigning the resource for order d0 to d5, reassigning the resource for d5 to d3, and canceling the resource for d3.

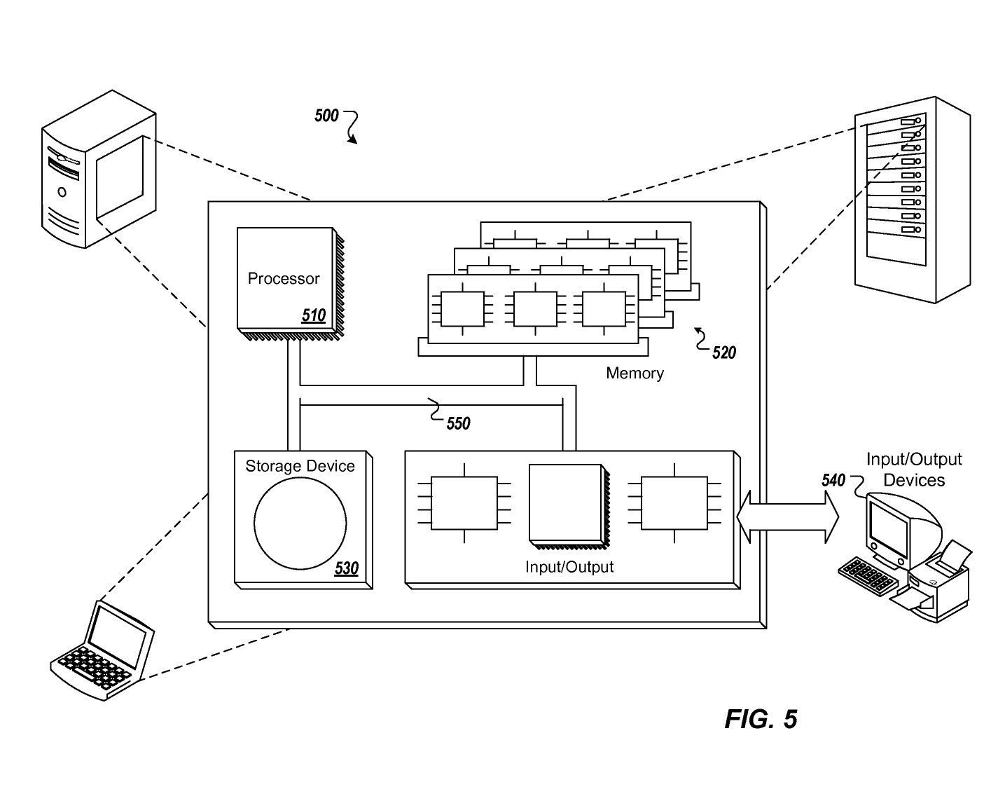

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit. The storage device 530 is capable of providing mass storage for the system 500. In one implementation, the storage device 530 is a computer-readable medium. In various different implementations, the storage device 530 may be a floppy disk device, a hard disk device, an optical disk device, or a tape device. The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for event-triggered reassignment of time-limited resources, the method being executed by one or more processors and comprising:
receiving, by the one or more processors, an event indicator;
determining, by the one or more processors and based on the event indicator, a particular demand and associated particular time-limited resources;
identifying, by the one or more processors and for the particular demand, one or more first candidate demands in an assignment plan, the assignment plan including a plurality of demands associated with a plurality of time-limited resources, each first candidate demand and associated time-limited resources satisfying one or more constraints defined by the particular demand and associated particular time-limited resources;
determining, by the one or more processors, whether at least one of the first candidate demands has not been processed; and
performing an action based on a result of determining whether at least one of the first candidate demands has not been processed.

2. The method of claim 1, wherein performing an action comprises:
in response to determining that at least one of the first candidate demands has not been processed, selecting one of the at least one of the first candidate demands for reassigning time-limited resources with the particular demand.

3. The method of claim 1, wherein performing an action comprises:
in response to determining that all of the first candidate demands have been processed, identifying, for each of the first candidate demands, one or more second candidate demands in the assignment plan, each second candidate demand and associated time-limited resources satisfying one or more second constraints defined by the respective first candidate demand and associated time-limited resources.

4. The method of claim 3, further comprising:
determining that at least one of the second candidate demands for the first candidate demands has not been processed; and
selecting one of the at least one of the second candidate demands for reassigning time-limited resources with the respective first candidate demand and the particular demand.

5. The method of claim 4, wherein the event is cancelling the particular demand from the assignment plan, and wherein reassigning time-limited resources with the respective first candidate demand and the particular demand comprises:
reassigning the particular time-limited resources for the particular demand to the respective first candidate demand; and
reassigning the time-limited resources for the respective first candidate demand to the selected second candidate demand.

6. The method of claim 1, wherein the one or more constraints defined by the particular demand and associated particular time-limited resources comprise at least one of:
a resource type of associated time-limited resources for the first candidate demand being same as a resource type of the particular time-limited resources;
associated time-limited resources for the first candidate demand having not arrived at a demander associated with the first candidate demand when the event occurs; or
the particular time-limited resources being in lifetime when the particular time-limited resources arrive at the demander associated with the first candidate demand.

7. The method of claim 1, further comprising:
building a hierarchical graph model by repeatedly identifying one or more candidate demands for proceeding demands in the assignment plan, the changed demand being the first proceeding demand; and
determining an optimal reassignment plan by searching the hierarchical graph model based on a cost function.

8. The method of claim 7, wherein the optimal reassignment plan includes least times of reassignment implementation.

9. A non-transitory computer-readable storage medium coupled to one or more processors and having instructions stored thereon which, when executed by the one or more processors, cause the one or more processors to perform operations for event-triggered reassignment of time-limited resources, the operations comprising:
receiving an event indicator;
determining a particular demand and associated particular time-limited resources based on the event indicator;
identifying, for the particular demand, one or more first candidate demands in an assignment plan, the assignment plan including a plurality of demands associated with a plurality of time-limited resources, each first candidate demand and associated time-limited resources satisfying one or more constraints defined by the particular demand and associated particular time-limited resources;
determining whether at least one of the first candidate demands has not been processed; and
performing an action based on a result of determining whether at least one of the first candidate demands has not been processed.

10. The computer-readable storage medium of claim 9, wherein performing an action comprises one of:
in response to determining that at least one of the first candidate demands has not been processed, selecting one of the at least one of the first candidate demands for reassigning time-limited resources with the particular demand, and
in response to determining that all of the first candidate demands have been processed, identifying, for each of the first candidate demands, one or more second candidate demands in the assignment plan, each second candidate demand and associated time-limited resources satisfying one or more second constraints defined by the respective first candidate demand and associated time-limited resources.

11. The computer-readable storage medium of claim 9, wherein the operations further comprise:
determining that at least one of the second candidate demands for the first candidate demands has not been processed; and
selecting one of the at least one of the second candidate demands for reassigning time-limited resources with the respective first candidate demand and the particular demand.

12. The computer-readable storage medium of claim 11, wherein the event is cancelling the particular demand from the assignment plan, and wherein reassigning time-limited resources with the respective first candidate demand and the particular demand comprises:
reassigning the particular time-limited resources for the particular demand to the respective first candidate demand; and
reassigning the time-limited resources for the respective first candidate demand to the selected second candidate demand.

13. The computer-readable storage medium of claim 9, wherein the one or more constraints defined by the particular demand and associated particular time-limited resources comprise at least one of:
a resource type of associated time-limited resources for the first candidate demand being same as a resource type of the particular time-limited resources;
associated time-limited resources for the first candidate demand having not arrived at a demander associated with the first candidate demand when the event occurs; or
the particular time-limited resources being in lifetime when the particular time-limited resources arrive at the demander associated with the first candidate demand.

14. The computer-readable storage medium of claim 9, wherein the operations further comprise:
building a hierarchical graph model by repeatedly identifying one or more candidate demands for proceeding demands in the assignment plan, the changed demand being the first proceeding demand; and
determining an optimal reassignment plan by searching the hierarchical graph model based on a cost function,
wherein the optimal reassignment plan includes least times of reassignment implementation.

15. A system, comprising:
a computing device; and
a computer-readable storage device coupled to the computing device and having instructions stored thereon which, when executed by the computing device, cause the computing device to perform operations for event-triggered reassignment of time-limited resources, the operations comprising:
receiving an event indicator;
determining a particular demand and associated particular time-limited resources based on the event indicator;
identifying, for the particular demand, one or more first candidate demands in an assignment plan, the assignment plan including a plurality of demands associated with a plurality of time-limited resources, each first candidate demand and associated time-limited resources satisfying one or more constraints defined by the particular demand and associated particular time-limited resources;
determining whether at least one of the first candidate demands has not been processed; and
performing an action based on a result of determining whether at least one of the first candidate demands has not been processed.

16. The system of claim 15, wherein performing an action comprises one of:
in response to determining that at least one of the first candidate demands has not been processed, selecting one of the at least one of the first candidate demands for reassigning time-limited resources with the particular demand, and
in response to determining that all of the first candidate demands have been processed, identifying, for each of the first candidate demands, one or more second candidate demands in the assignment plan, each second candidate demand and associated time-limited resources satisfying one or more second constraints defined by the respective first candidate demand and associated time-limited resources.

17. The system of claim 15, wherein the operations further comprise:
determining that at least one of the second candidate demands for the first candidate demands has not been processed; and
selecting one of the at least one of the second candidate demands for reassigning time-limited resources with the respective first candidate demand and the particular demand.

18. The system of claim 17, wherein the event is cancelling the particular demand from the assignment plan, and wherein reassigning time-limited resources with the respective first candidate demand and the particular demand comprises:
reassigning the particular time-limited resources for the particular demand to the respective first candidate demand; and
reassigning the time-limited resources for the respective first candidate demand to the selected second candidate demand.

19. The system of claim 15, wherein the one or more constraints defined by the particular demand and associated particular time-limited resources comprise at least one of:
a resource type of associated time-limited resources for the first candidate demand being same as a resource type of the particular time-limited resources;
associated time-limited resources for the first candidate demand having not arrived at a demander associated with the first candidate demand when the event occurs; or
the particular time-limited resources being in lifetime when the particular time-limited resources arrive at the demander associated with the first candidate demand.

20. The system of claim 15, wherein the operations further comprise:
building a hierarchical graph model by repeatedly identifying one or more candidate demands for proceeding demands in the assignment plan, the changed demand being the first proceeding demand; and
determining an optimal reassignment plan by searching the hierarchical graph model based on a cost function,
wherein the optimal reassignment plan includes least times of reassignment implementation.
